(19) United States
(12) Patent Application Publication
(10) Pub. No.: US 2024/0419179 A1
(43) Pub. Date: Dec. 19, 2024

(54) INFORMATION PROCESSING DEVICE, CONTROL METHOD, AND STORAGE MEDIUM

(71) Applicant: CANON KABUSHIKI KAISHA, Tokyo (JP)

(72) Inventors: AKITERU NAKA, Tokyo (JP); HISAYOSHI FURIHATA, Tokyo (JP); MASAKAZU FUJIKI, Kanagawa (JP)

(21) Appl. No.: 18/679,183

(22) Filed: May 30, 2024

(30) Foreign Application Priority Data
Jun. 13, 2023 (JP) 2023-096695

(51) Int. Cl. G05D 1/243; G05D 1/245; G05D 111/50

(52) U.S. Cl. CPC G05D 1/2437; G05D 1/245; G05D 2111/52

(57) ABSTRACT

An information processing device includes a route information acquisition unit configured to acquire information about a route on which a movable apparatus moves; an environment information acquisition unit configured to acquire environment information on the route for moving the movable apparatus; an estimation unit configured to estimate a self-position and orientation of the movable apparatus and store a result of the estimation in the environment information; an accuracy calculation unit configured to calculate an accuracy for estimating a self-position and orientation of the movable apparatus on the basis of the environment information; and a route setting unit configured to update a route of the movable apparatus according to an accuracy calculated by the accuracy calculation unit.

### BACKGROUND

### Technical Field

The present disclosure relates to an information processing device, a control method, a storage medium, and the like.

### Description of the Related Art

A position and orientation estimation technology has been proposed to automatically move a movable apparatus such as a transport vehicle within an environment such as a factory or a logistics warehouse. Examples of the transport vehicle include an automated guided vehicle (AGV). AGV is an abbreviation for an automated guided vehicle.

When a movable apparatus is caused to travel autonomously, a method is known that uses a reliability of position and orientation estimation so that a route on which the movable apparatus travels is a route with high accuracy of position and orientation estimation. For example, in Japanese Patent Laid-Open No. 2020-166702, reliability map data is created in which each position in space is associated with the reliability of position and orientation estimation at a corresponding position.

When a route is generated, the reliability map data is referred to and high reliability areas whose reliability is equal to or greater than a threshold value are determined to generate a route that passes through the high reliability areas.

However, in the method of Japanese Patent Laid-Open No. 2020-166702, there has been a problem that the movable apparatus cannot be operated stably when there is no reliability map data.

### SUMMARY

An information processing device according to an embodiment of the present disclosure includes at least one memory storing instructions and at least one processor that, upon execution of the instructions, configures the at least one processor to function as:
a route information acquisition unit configured to acquire information about a route on which a movable apparatus moves;
an environment information acquisition unit configured to acquire environment information on the route for moving the movable apparatus;
an estimation unit configured to estimate a self-position and orientation of the movable apparatus and store a result of the estimation in the environment information;
an accuracy calculation unit configured to calculate an accuracy for estimating a self-position and orientation of the movable apparatus on the basis of the environment information; and a route setting unit configured to update a route of the movable apparatus according to an accuracy calculated by the accuracy calculation unit.

Further features of the present disclosure will become apparent from the following description of embodiments with reference to the attached drawings.

### BRIEF DESCRIPTION OF THE DRAWINGS

FIG. 1 is a schematic diagram which shows an example of use in a warehouse including a movable apparatus according to a first embodiment of the present disclosure.

FIG. 2 is a hardware configuration diagram of an information processing device according to the first embodiment of the present disclosure.

FIG. 3 is a data flow diagram of the information processing device according to the first embodiment of the present disclosure.

FIG. 4 is a flowchart which shows processing executed by the information processing device according to the first embodiment of the present disclosure.

FIG. 5 is an image diagram of a route according to the first embodiment of the present disclosure.

FIG. 6 is a flowchart which shows an update processing procedure according to the first embodiment of the present disclosure.

FIG. 7 is an image diagram of an updated route according to the first embodiment of the present disclosure.

FIG. 8 is a flowchart which shows a notification processing procedure according to the first embodiment of the present disclosure.

FIG. 9 is a flowchart which shows an update processing procedure according to a second embodiment of the present disclosure.

FIG. 10 is an image diagram of an updated route according to the second embodiment of the present disclosure.

FIG. 11 is a flowchart which shows a notification processing procedure according to a third embodiment of the present disclosure.

FIG. 12 is an image diagram of a screen where a user is notified according to the third embodiment of the present disclosure.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

First, the first embodiment of the present disclosure will be described. The present embodiment is an example in which the present disclosure is applied to control of a movable apparatus that transports goods in a logistics warehouse.

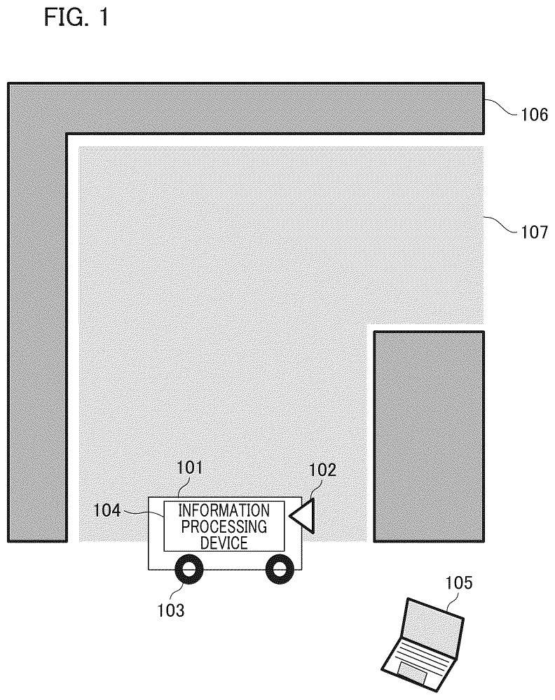

FIG. 1 is a schematic diagram which shows an example of use in a warehouse that includes a movable apparatus according to the first embodiment. A movable apparatus 101 includes a sensor 102 such as a stereo camera, a vehicle wheel 103, and an information processing device 104.

A user can directly operate the movable apparatus 101 using a terminal device 105 via a network such as Wi-Fi. The terminal device 105 is, for example, a laptop. The terminal device 105 may be any of other information processing devices.

Additionally, the user can operate the terminal device 105 to set a travel route of the movable apparatus 101 in advance. The movable apparatus 101 can move in a travelable area 107 excluding a wall 106 present in the warehouse in a combination of a travel direction (forward travel, backward travel) and a turning direction according to the travel route set in advance.

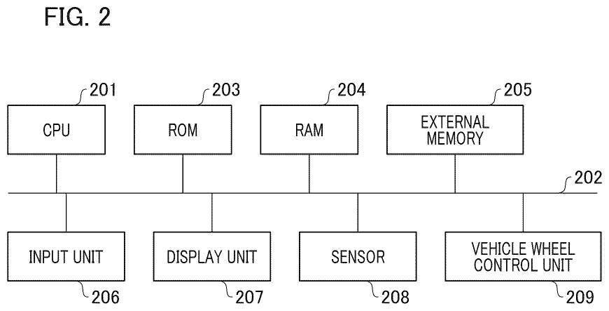

FIG. 2 is a hardware configuration diagram of the information processing device 104 in FIG. 1. A reference numeral 201 is for a CPU, which controls various devices connected to the system bus 202. CPU is an abbreviation for a central processing unit.

A reference numeral 203 is for a ROM, which stores a BIOS program and a booting program. ROM is an abbreviation for a read only memory. BIOS is an abbreviation for a basic input output system. A reference numeral 204 is for a RAM, which is used as a main storage device of the CPU 201. RAM is an abbreviation for a random access memory.

A reference numeral 205 is for an external memory, which stores a program for operating the movable apparatus 101 in FIG. 1. A reference numeral 206 is for an input unit, such as a keyboard, a mouse, or a robot controller, which performs processing according to an input of information and the like.

A display unit 207 displays a result of the calculation by the information processing device 104 according to an instruction from the CPU 201. Note that the display unit 207 may be of any type, such as a liquid crystal display device, a projector, or an LED indicator.

A reference numeral 208 is for a sensor such as a monocular camera, a stereo camera, a depth camera, or a LiDAR, which outputs measurement values such as image data and shape data. LiDAR is an abbreviation for light detection and ranging. A reference numeral 209 is for a vehicle wheel control unit, which receives an instruction from the CPU 201 and controls the vehicle wheel 103 in FIG. 1.

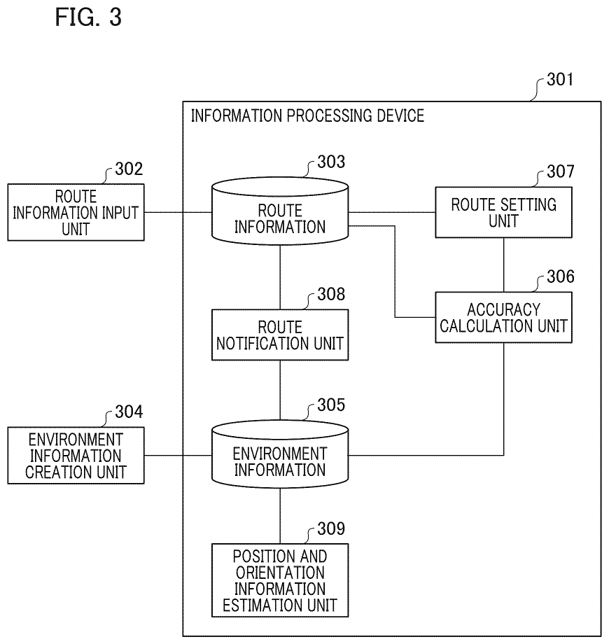

FIG. 3 is a data flow diagram which shows a relationship between a program code and data handled in the present embodiment. A reference numeral 301 is for an information processing device corresponding to the information processing device 104 in FIG. 1.

A reference numeral 302 is for a route information input unit that receives the travel route set via the terminal device 105 in FIG. 1 and inputs route information 303. A reference numeral 304 is for an environment information creation unit that acquires measured values via the sensor 102 in FIG. 1 and creates environment information 305 representing the surrounding environment based on the measured values.

A reference numeral 306 is for an accuracy calculation unit that calculates an accuracy of a calculated self-position of the movable apparatus 101 in FIG. 1 for a part of the route included in the route information 303 on the basis of the environment information 305. A reference numeral 307 is for a route setting unit which updates the route of the movable apparatus 101 based on the accuracy calculated by the accuracy calculation unit 306.

A reference numeral 308 is for a route notification unit which notifies the vehicle wheel control unit 209 and the display unit 207 of the route based on current position and orientation information obtained from the route information 303 and the environment information 305. A reference numeral 309 is for a position and orientation information estimation unit that acquires a measured value via the sensor 102 in FIG. 1 and estimates the self-position of the movable apparatus 101 based on the measured value. The self-position information created by the position and orientation information estimation unit 309 is stored in the environment information 305.

A processing procedure using a flowchart in the following description is an example, and the present disclosure is not limited to this. In addition, as long as results of the present disclosure are satisfied, procedures can be combined, a plurality of pieces of processing can be combined, or the processing may also be subdivided. Moreover, it is possible to extract each piece of processing individually to function as a single functional element, and use it in combination with processing other than processing shown.

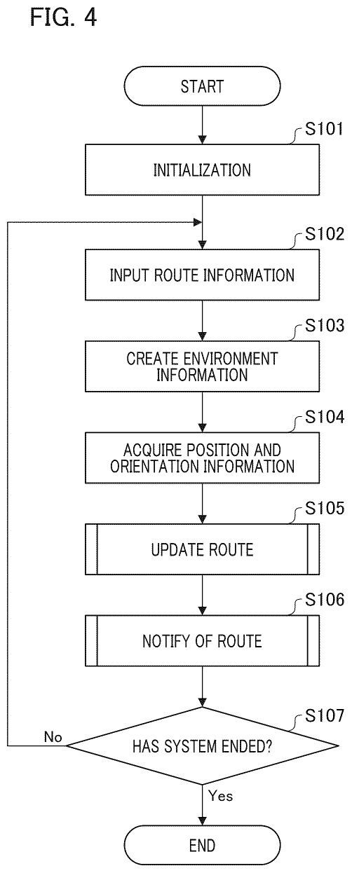

Hereinafter, embodiments of the present disclosure will be described with reference to the drawings and flowcharts. FIG. 4 is a flowchart which shows a processing procedure according to the present embodiment.

In step S101, the information processing device 301 initializes the information processing device 301. In this initialization, the information processing device 301 reads a program from an external memory 205 in FIG. 2, and puts the information processing device 301 into an operable state.

In step S102, the route information input unit 302 performs processing of inputting the travel route of the movable apparatus 101 as the route information 303. In the route information 303, for example, a travel position is expressed using a coordinate point with a certain position as an origin, and the coordinate point is expressed using one or more columns.

In step S103, the environment information creation unit 304 performs processing of creating environment information 305 based on measured values obtained from the sensor 102 in FIG. 1. The environment information 305 includes, for example, image data photographed on a corresponding spot by a stereo camera or image data photographed in the past, and shape data measured on a corresponding spot by LiDAR or shape data measured in the past.

In step S104, the position and orientation information estimation unit 302 outputs self-position information based on the measured values acquired from the sensor 102 in FIG. 1. In the present embodiment, the sensor 102 is fixed to the movable apparatus 101, and the sensor 102 moves and turns in conjunction with moving and turning of the movable apparatus 101, so that the position and orientation of the movable apparatus 101 corresponds to the position and orientation of the sensor 102.

In addition, as a position and orientation estimation method using a sensor, an SLAM technology and a method of Engel et al. (Literature (J. Engel, T. Schps, and D. Cremers. LSD-SLAM: Large-Scale Direct Monocular SLAM. In European Conference on Computer Vision (ECCV), 2014) are used.

SLAM is an abbreviation for simultaneous localization and mapping. In this method, self-position and orientation estimation and map creation are simultaneously performed in a wide-area environment such as outdoors.

In step S105, the information processing device 301 updates the route information 303. A method for updating the route information 303 will be described below.

In step S106, the route notification unit 308 performs notification of the route information 303. A notification method of the route information 303 will be described below.

In step S107, the information processing device 301 determines whether to end entire processing of the information processing device 301 as a system end. When the information processing device 301 determines that the system has ended, the processing ends. Specifically, the information processing device 301 ends the processing when the input unit 206 in FIG. 2 has received an end instruction from the user. When the information processing device 301 determines that the system has not ended, the procedure returns to step S102 and continues the processing.

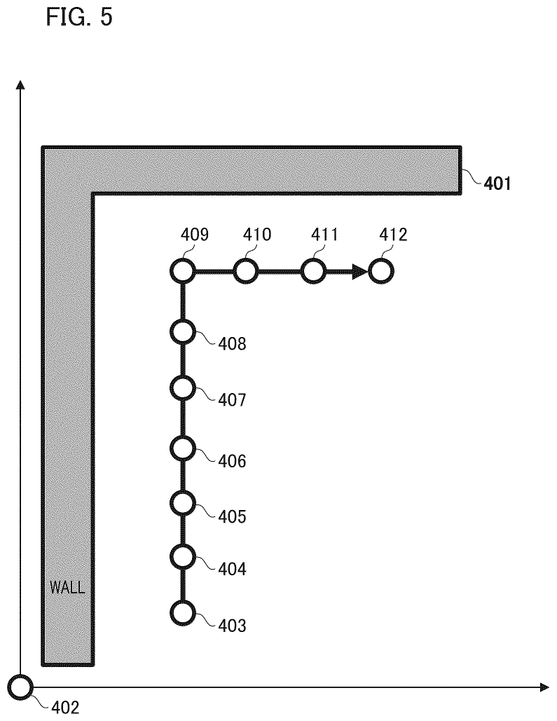

FIG. 5 is an image diagram of a route in the route information 303 of FIG. 3. A reference numeral 401 indicates a wall area on which the movable apparatus 101 of FIG. 1 cannot travel. A reference numeral 402 indicates origin coordinates used in the route information 303.

The route information 303 is configured by a coordinate point 403, a coordinate point 404, a coordinate point 405, a coordinate point 406, a coordinate point 407, a coordinate point 408, a coordinate point 409, a coordinate point 410, a coordinate point 411, and a coordinate point 412. The coordinate point 403 is expressed as, for example, a position from an origin 402 and is expressed as (100, 50) when it is 100 in an X direction and 50 in a Y direction from the origin.

When the travel route of the movable apparatus 101 is set using the terminal device 105 in FIG. 1, for example, a route from the coordinate point 403 to the coordinate point 412 is input as the route information 303. The route information 303 includes an area or a coordinate point where the movable apparatus 101 cannot travel, but it is not particularly limited as long as it is information that can be input in advance, such as an amount of foot traffic, lighting conditions, and a shape of a surface.

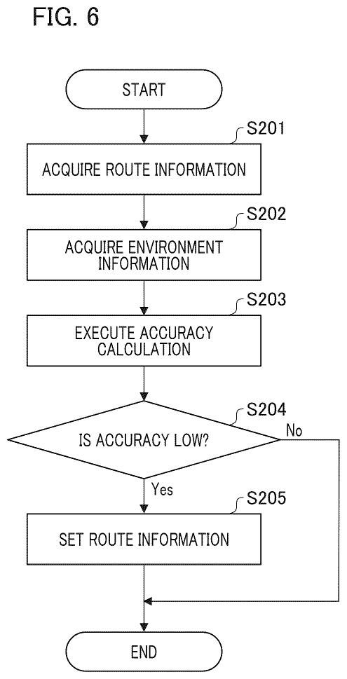

FIG. 6 is a flowchart which shows a processing procedure for updating the route information 303 in step S105 of FIG. 4.

In step S201, the accuracy calculation unit 306 performs processing of acquiring a basic route from the route information 303 input by the route information input unit 302. The basic route is, for example, part of the route information 303 such as the coordinate point 403 to the coordinate point 412 in FIG. 5. Here, the coordinate points are used as the basic route, but even an area of a certain size instead of a point may also be used.

In step S202, the accuracy calculation unit 306 performs processing of acquiring the environment information 305 created by the environment information creation unit 304.

In step S203, the accuracy calculation unit 306 performs processing of calculating the accuracy on the basic route acquired in step S201. For example, when the movable apparatus 101 moves from the coordinate point 403 to the coordinate point 412 on the basic route, the accuracy calculation unit 306 acquires image data photographed by a stereo camera as the environment information 305, and calculates the accuracy based on image data photographed at each coordinate point.

Here, it is assumed that the accuracy is calculated for each coordinate point, but it may be calculated randomly when the movable apparatus is moving, or it may be calculated at certain fixed time intervals. The accuracy calculation unit 306 performs image processing on the photographed image data to determine a degree of accuracy, which is calculated based on the number of edges and the number of feature points detected in the image data.

In addition, the accuracy calculation unit 306 may calculate a degree of accuracy using a degree of unevenness of shape data, or the like when the shape data measured by LiDAR can be used as the environment information 305.

The accuracy calculation unit 306 may calculate the accuracy on the basis of an image included in the environment information. The accuracy calculation unit 306 may calculate the accuracy on the basis of a shape included in the environment information.

In step S204, the route setting unit 307 performs processing of comparing whether the accuracy calculated in step S203 is higher or lower than a threshold value. When the route setting unit 307 determines that the accuracy is higher than the threshold value, the processing ends.

When the route setting unit 307 determines that the accuracy is equal to or lower than the threshold value (the accuracy is low), the processing of step S205 is executed. Here, it is assumed that the route setting unit 307 compares the accuracy with a threshold value, but it may also compare a cumulative result of the accuracy calculated so far with the threshold value.

In step S205, the route setting unit 307 performs processing of updating the route so that it becomes a different route from step S202. For example, when it is determined that the accuracy is low at the coordinate point 406 while the movable apparatus 101 is on a route from the coordinate point 403 to the coordinate point 409 in FIG. 5, the route setting unit 307 performs processing of setting a route at a position different from the coordinate point 407.

For example, a route is set to move away from an area where traveling is not possible, and after setting, a position that is a certain distance from the area where traveling is not possible is set to the route in consideration of the degree of accuracy. In addition, a change in the direction of the movable apparatus 101 may also be set to the route, or the route may be changed to turn diagonally or backwards depending on the degree of accuracy or a final route position.

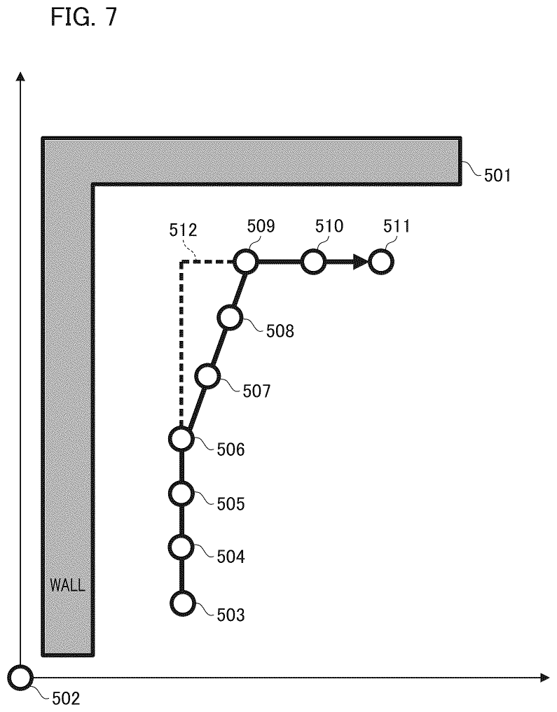

FIG. 7 is an image diagram of an updated route obtained by executing the flowchart in FIG. 6 for the route in FIG. 5. A reference numeral 501 indicates a wall area on which the movable apparatus 101 of FIG. 1 cannot travel. A reference numeral 502 indicates origin coordinates used in the route information 303.

The updated route information 303 is configured by a coordinate point 503, a coordinate point 504, a coordinate point 505, a coordinate point 506, a coordinate point 507, a coordinate point 508, a coordinate point 509, a coordinate point 510, and a coordinate point 511. The coordinate point 503 is expressed, for example, as a position from the origin 502, and is expressed as (100, 50) when it is 100 in the X direction and 50 in the Y direction from the origin.

A reference numeral 512 indicates the route before being updated, and it can be seen that the route information 303 in FIG. 5 has been updated and the route has been changed to a route from the coordinate point 503 to the coordinate point 511 by executing the flowchart in FIG. 6.

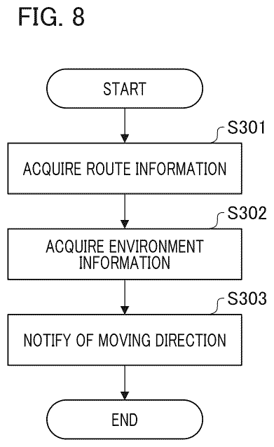

FIG. 8 is a flowchart which shows a processing procedure for notifying the route information 303 in step S106 of FIG. 4.

In step S301, the route notification unit 308 performs processing of acquiring the route information 303. In step S302, the route notification unit 308 performs processing of acquiring the environment information 305. In step S303, the route notification unit 308 performs processing of notifying the vehicle wheel control unit 209 of FIG. 2 of a moving direction from a current position and orientation information obtained from the route information 303 and the environment information 305. When the vehicle wheel control unit 209 is notified of it in step S303, the processing in FIG. 8 ends.

As described above, the movable apparatus 101 can stably travel on a route configured with higher accuracy by updating the route information 303.

### Modified Example 1-1

In the first embodiment, the route setting unit 307 has considered an area where traveling is not possible in the processing of updating the route. However, the processing of updating the route may also be performed in consideration of not only the area where traveling is not possible, but also a person or an object.

For example, when a person or an object is detected as the environment information 305, the route may be set in a direction away from the person or object. Furthermore, the route may be set to be as short as possible in consideration of a travel distance.

In addition, when the route information 303 includes information related to safety, such as areas where traveling is prohibited, the route may be set so that the movable apparatus travels away from the areas where traveling is prohibited to be a route on which the movable apparatus can travel more safely.

### Modified Example 1-2

In the first embodiment, the accuracy calculation unit 306 has considered a result of the environment information 305 in the processing of calculating the accuracy. However, the accuracy may be calculated by combining not only the environment information 305 but also the route information 303. For example, the accuracy may be calculated on a premise that the movable apparatus travels along the area where traveling is not possible, obtained from the route information 303.

Furthermore, the accuracy may be calculated by taking into consideration the amount of foot traffic, the lighting conditions of a passage, and the shape of a surface of the passage. For example, the accuracy may be calculated to be low when there is a lot of foot traffic, the accuracy may be calculated to be low when there are large changes in lighting such as getting brighter or darker, or the accuracy may be calculated to be low when there is an unevenness on the surface of the passage.

### Second Embodiment

Next, a second embodiment of the present disclosure will be described. In the first embodiment, it has been shown that the movable apparatus 101 can travel stably by updating a route when the accuracy has decreased.

In the present embodiment, a method of updating the route so that the movable apparatus 101 can travel stably when a decrease in accuracy is expected will be described.

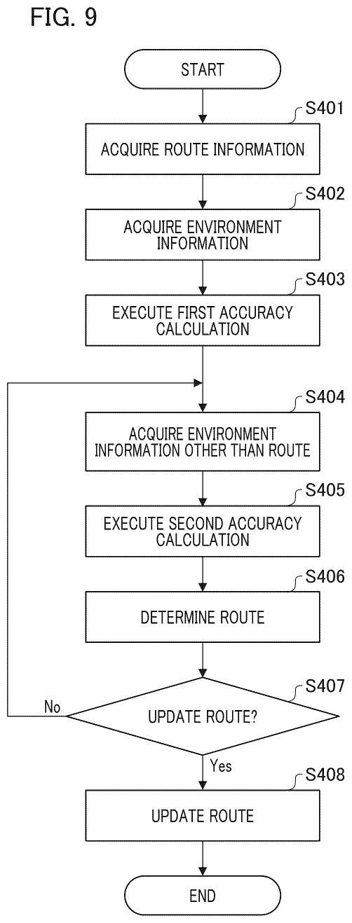

FIG. 9 is a flowchart which shows a processing procedure for updating the route information 303 when a decrease in accuracy is expected in step S105 of FIG. 4. In step S401, the accuracy calculation unit 306 performs processing of acquiring a basic route from the route information 303 input by the route information input unit 302.

In step S402, the accuracy calculation unit 306 performs processing of acquiring the environment information 305 created by the environment information creation unit 304.

In step S403, the accuracy calculation unit 306 performs processing of calculating the accuracy on the basic route acquired in step S401. For example, when the movable apparatus 101 moves on the basic route from the coordinate point 403 to the coordinate point 412 in FIG. 5, the accuracy calculation unit 306 acquires image data photographed by the stereo camera as the environment information 305 and calculates the accuracy based on the image data photographed at the coordinate point 403.

In step S404, the accuracy calculation unit 306 performs processing of calculating the accuracy other than on the basic route acquired in step S401. For example, when a route from the coordinate point 403 to the coordinate point 408 in FIG. 5 is a basic route, the environment information 305 at a position 10 or more away from a coordinate point of the basic route in the X direction is acquired from the environment information 305 created in the past.

Here, the position is shifted by a fixed value of 10 in the X direction, but it may be acquired randomly, or may be a value in consideration of a distance from the area where traveling is not possible. In addition, when the sensor 102 is fixed only in the front direction of the movable apparatus 101, the environment information 305 obtained will differ depending on a mounting position of the sensor 102, so that even if the movable apparatus 101 turns on a corresponding spot, it may be treated as a route other than the basic route.

In step S405, the accuracy calculation unit 306 performs processing of calculating the accuracy on a route different from the basic route acquired in step S404. For example, in step S404, when image data photographed by a stereo camera when the movable apparatus has turned 180 degrees on a spot at the coordinate point 403 is acquired as the environment information 305, the accuracy of a route different from the basic route will be a result of the calculation when the movable apparatus has turned at the position.

In step S406, the route setting unit 307 determines a route using the accuracy calculated in step S403 and the accuracy calculated in step S405. Specifically, the route setting unit 307 performs processing of determining whether to use the route acquired in step S401 as it is or to use a route different from the basic route acquired in step S404.

With regard to determination on which route to use, for example, when the accuracy calculated in step S403 is sufficiently high and the accuracy acquired in step S405 is low, the route handled in step S403 is determined. As another determination method, for example, when the accuracy calculated in step S403 is low and the accuracy acquired in step S405 is high, a route different from the basic route is determined.

In step S407, the route setting unit 307 determines whether to finalize and update the route determined in step S406. When the route setting unit 307 has determined to update with the route determined in step S406, the processing in step S408 is executed.

When the route setting unit 307 has determined that the route determined in step S406 is not to be updated, the processing in step S404 is executed. The route is determined and updated, for example, when the route determined in step S406—can be configured by replacing the route acquired in step S401 while maintaining a sufficiently high accuracy.

In step S408, the route setting unit 307 performs processing of updating the route determined in steps S404 to S407. After the update processing is performed in step S408, the processing in FIG. 9 ends.

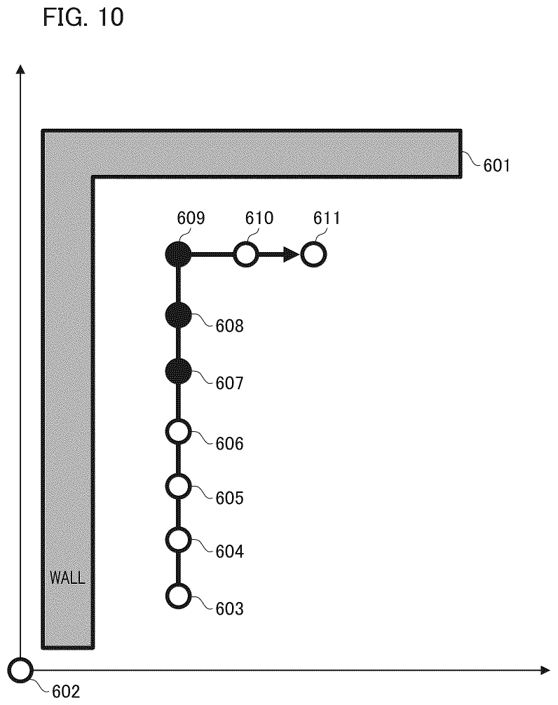

FIG. 10 is an image diagram of an updated route obtained by executing the flowchart in FIG. 9 for the route in FIG. 5. A reference numeral 601 indicates a wall area on which the movable apparatus 101 of FIG. 1 cannot travel. A reference numeral 602 indicates origin coordinates used in the route information 303.

The updated route information 303 is configured from a coordinate point 603, a coordinate point 604, a coordinate point 605, a coordinate point 606, a coordinate point 607, a coordinate point 608, a coordinate point 609, a coordinate point 610, and a coordinate point 611. The coordinate point 603 is expressed, for example, as a position from the origin 602, and is expressed as (100, 50) when it is 100 in the X direction and 50 in the Y direction from the origin.

The coordinate point 607, the coordinate point 608, and the coordinate point 609 indicate that the route information 303 in FIG. 5 has been updated by executing the flowchart in FIG. 9. Furthermore, the coordinate point 607 has the same coordinates as the coordinate point 407 in FIG. 5, but indicates that the movable apparatus is turning and traveling backwards.

The updated route information 303 indicates that the movable apparatus travels forward from the coordinate point 603 to the coordinate point 607, travels backward from the coordinate point 607 to the coordinate point 609, and travels forward from the coordinate point 609 to the coordinate point 612.

As described above, by updating the route information 303, the movable apparatus 101 can stably travel on a route configured with higher accuracy even when a decrease in accuracy is expected.

### Modified Example 2-1

In the second embodiment, the route setting unit 307 searches for a more accurate route based on past photographic data when a decrease in accuracy is expected as processing of updating a route. However, similar to Modified example 1-1, the update processing may be performed by taking into account a person or an object. Furthermore, the update processing may be performed by taking into account safety aspects such as a traveling distance and areas where travel is prohibited.

Additionally, the processing of updating a route may be performed by combining accuracy, a person, an object, a travel distance, and the like during the search. For example, the route may be updated by first considering a person and an object, and then by considering accuracy. Furthermore, when the accuracy decreases significantly during actual traveling after the route is updated, the search may be performed again by returning to a point where the search is started once traveling is performed, and the route may be updated.

This is because there can be a difference in accuracy calculation results at the time of the search again, caused by the environment information 305 being updated by actual traveling.

### Third Embodiment

Next, a third embodiment of the present disclosure will be described. In the first embodiment and second embodiment, it has been described that the movable apparatus 101 can travel stably by updating a route and notifying the vehicle wheel control unit 209 of the updated route.

In the third embodiment, a method for notifying the user of a route on which the movable apparatus can travel stably, and then allowing the user to reset the route so that the movable apparatus can travel stably will be described.

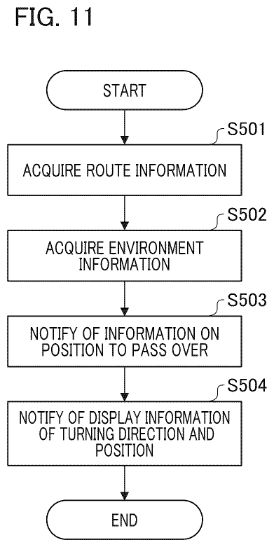

FIG. 11 is a flowchart which shows a processing procedure for notifying the user of a route on which the movable apparatus 101 can travel stably in step S106 of FIG. 4.

In step S501, the route notification unit 308 performs processing of acquiring a basic route from the route information 303 input by the route information input unit 302.

In step S502, the route notification unit 308 performs processing of acquiring the environment information 305 created by the environment information creation unit 304.

In step S503, the route notification unit 308 performs processing of notifying the display unit 207 of information on positions through which the movable apparatus 101 of the updated route information 303 passes. Here, the route notification unit 308 may notify the positional information of the route information 303 before and after the update, or may notify only the positional information of the route information 303 after the update.

In step S504, the route notification unit 308 performs processing of notifying the display unit 207 of information on a turning direction of the movable apparatus 101 of the updated route information 303 and the positional information when the movable apparatus is turning. When notification to the display unit 207 is performed in step S504, the processing in FIG. 11 ends.

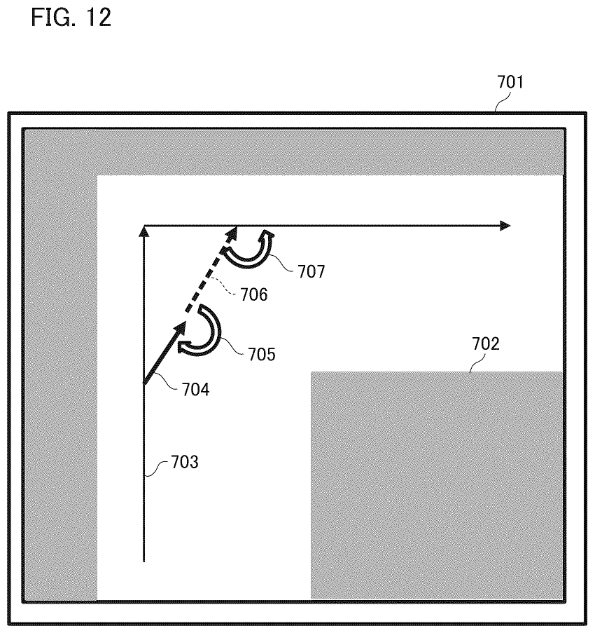

FIG. 12 is an image diagram of the user notification screen obtained by executing the flowchart in FIG. 11. A reference numeral 701 is a route screen displayed on the display unit 207 in FIG. 2. The user looks at content displayed on the route screen 701 and confirms a route on which the movable apparatus 101 in FIG. 1 stably travels. A reference numeral 702 indicates a wall area on which the movable apparatus 101 cannot travel.

A reference numeral 703 indicates the route before an update. Reference numerals 704, 705, 706, and 707 indicate routes notified by executing the processing of FIG. 11. A reference numeral 704 indicates that the movable apparatus travels along a different position from the route 703 before an update.

A reference numeral 705 indicates turning of the movable apparatus 101 by its position, angle, and direction. A reference numeral 706 indicates that a traveling direction of the movable apparatus 101 is backward. A reference numeral 707 indicates the turning of the movable apparatus 101 by its position, angle, and direction.

As described above, the movable apparatus 101 can notify the user of a route on which it can travel stably, and then allow the user to reset the route so that it can travel stably.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device, or the like through a network or various storage media. Then, a computer (or a CPU, an MPU, or the like) of the information processing device, or the like may be configured to read and execute the program. In such a case, the program and the storage medium storing the program configure the present disclosure.

In addition, the present disclosure includes those realized using at least one processor or circuit configured to perform functions of the embodiments described above. For example, a plurality of processors may be used for distribution processing of perform functions of the embodiments described above.

This application claims the benefit of priority from Japanese Patent Application No. 2023-096695, filed on Jun. 13, 2023, which is hereby incorporated by reference herein in its entirety.

What is claimed is:

1. An information processing device comprising:
at least one memory storing instructions and at least one processor that, upon execution of the instructions, configures the at least one processor to function as:
a route information acquisition unit configured to acquire information about a route on which a movable apparatus moves;
an environment information acquisition unit configured to acquire environment information on the route for moving the movable apparatus;
an estimation unit configured to estimate a self-position and orientation of the movable apparatus and store a result of the estimation in the environment information;
an accuracy calculation unit configured to calculate an accuracy for estimating a self-position and orientation of the movable apparatus on the basis of the environment information; and
a route setting unit configured to update a route of the movable apparatus according to an accuracy calculated by the accuracy calculation unit.

2. The information processing device according to claim 1,
wherein the accuracy calculation unit calculates an accuracy using an image included in the environment information.

3. The information processing device according to claim 1,
wherein the accuracy calculation unit calculates an accuracy using a shape included in the environment information.

4. The information processing device according to claim 1,
wherein the route setting unit performs an update based on the accuracy calculated for each one or more areas included in an acquired.

5. The information processing device according to claim 1,
wherein the accuracy calculation unit calculates an accuracy used to estimate a self-position and orientation of the movable apparatus for each one or more areas which are not included in the route acquired by the route information acquisition unit, and
the route setting unit estimates one or more areas which are not included in the route acquired by the route information acquisition unit as a route of the movable apparatus according to an accuracy calculated by the accuracy calculation unit.

6. The information processing device according to claim 1, wherein execution of the stored instructions further configures the at least one processor to function as, a display unit that outputs route information set by the route information setting unit to a display device.

7. The information processing device according to claim 6,
wherein the display unit displays a traveling direction and a turning direction of the movable apparatus.

8. A control method comprising:
a route information acquisition process of acquiring information on a route for moving a movable apparatus;
an environment information acquisition process of acquiring environment information on the route for moving the movable apparatus;
an estimation process of estimating a self-position and orientation of the movable apparatus and storing a result of the estimation in the environment information;
an accuracy calculation process of calculating an accuracy for estimating the self-position and orientation of the movable apparatus on the basis of the environment information; and
a route setting process of updating a route of the movable apparatus according to the accuracy calculated in the accuracy calculation process.

9. A non-transitory computer-readable storage medium configured to store a computer program comprising instructions for executing following processes:
a route information acquisition process of acquiring information on a route for moving a movable apparatus;
an environment information acquisition process of acquiring environment information on the route for moving the movable apparatus;
an estimation process of estimating a self-position and orientation of the movable apparatus and storing a result of the estimation in the environment information;
an accuracy calculation process of calculating an accuracy for estimating the self-position and orientation of the movable apparatus on the basis of the environment information; and
a route setting process of updating a route of the movable apparatus according to the accuracy calculated in the accuracy calculation process.
